(19) United States
(12) Patent Application Publication
(10) Pub. No.: US 2011/0238371 A1
(43) Pub. Date: Sep. 29, 2011

(54) METHOD FOR BRAKING STATE MONITORING AND WIND ENERGY INSTALLATION FOR CARRYING OUT THE METHOD

(75) Inventors: Jens Altemark, Rendsburg (DE); Matthias Brueckner, Rendsburg (DE)

(73) Assignee: REpower Systems AG, Hamburg (DE)

(21) Appl. No.: 13/072,270

(22) Filed: Mar. 25, 2011

(30) Foreign Application Priority Data
Mar. 25, 2010 (DE) 10 2010 012 957.7

(51) Int. Cl. G06F 15/00

(52) U.S. Cl. 702/182

(57) ABSTRACT

A method for determining the state of a braking apparatus of a wind energy installation can include obtaining data relating to load behavior of the braking apparatus, recording a measured value during a time period between a start of a braking process and an end of the braking process, and determining a brake state characteristic value based on the data and the measured value. A wind energy installation for performing the method can include a braking apparatus, a sensor, a control unit configured to instruct the sensor to record a measured value in a time period between a start of a braking process and an end of a braking process, a data memory configured to store data relating to load behavior of the braking apparatus, and a computation module configured to determine a brake state characteristic value based on the data and the measured value.

### REFERENCE TO RELATED APPLICATIONS

This application claims the priority of German Patent Application No. 10 2010 012 957.7, filed Mar. 25, 2010, the contents of which are incorporated herein by reference.

### FIELD OF THE INVENTION

The invention relates to a method for determining the state of a braking apparatus of a wind energy installation, and to a wind energy installation for carrying out the method.

### BACKGROUND OF THE INVENTION

Modern wind energy installations generally have braking apparatuses, for example in order to brake the rotor in the event of malfunctions or for maintenance purposes, or for fixing the machine housing of the wind energy installation on the tower. In the first-mentioned situation, these are generally mechanical disk brakes, which act directly on the rotor rotation shaft, or indirectly via a transmission on the rotor. Mechanical brakes such as these have to be monitored in order to identify a malfunction in good time, and to preclude a safety risk. Various methods are known for this purpose. DE 10 2004 051 054 A1, from the same applicant, discloses an installation in which a braking apparatus for braking a component which is connected to an actuating drive is monitored using a sensor which detects a malfunction of the brake. This has the disadvantage that, although a malfunction of the brake is identified, no brake state characteristic value is, however, determined when the brake is operating correctly.

### SUMMARY OF THE INVENTION

The invention is based on the object of providing a method and a wind energy installation, in which the state of the brake can be determined with little effort. The object is achieved by the features broadly disclosed herein. Advantageous embodiments are specified in the disclosure.

In the method according to the invention, data relating to the load behavior of braking apparatuses of the relevant type is provided. A measured value is recorded in the time period between the start of a braking process and the end of a braking process. The data and the measured value are combined to form a brake state characteristic value.

First of all, a number of terms will be explained. The start of a braking process is the time at which the brake linings are brought into contact with the brake body. The brake body is generally a brake disk. The braking process is ended either when the brake linings are detached from the brake disk again, or when the rotation has been braked to zero or virtually zero.

The invention is based on the discovery that variables which provide a direct conclusion about the state of the braking apparatus can generally be measured directly only with a certain amount of effort. Dedicated sensors must be provided, which in some cases operate in severe conditions and for this reason result in maintenance effort. This applies, for example, to direct measurements of the brake lining wear and to direct measurements of the temperature. Instead of this, the invention proposes the use of measured values which can be measured easily or are available in any case. These measured values which are readily available are combined with data from which it is evident what the load behavior of the braking apparatus is, that is to say how a braking apparatus of the relevant type reacts to specific braking processes. The cost in obtaining the relevant data need be invested only once. The data can then be used for all braking apparatuses of this type. The information is combined in the brake state characteristic value and can be made available, for example, to the control system of the wind energy installation. By way of example, the brake state characteristic value may be such that it allows a conclusion to be drawn about the temperature or the wear of the braking apparatus. In one advantageous embodiment, the brake state characteristic value includes a measure for the energy consumption of the braking apparatus.

Braking processes in wind energy installations differ from conventional braking processes, for example in the case of vehicles, in that further energy is supplied to the system during the braking process. This is because the wind acts on the rotor even during the braking process, and the amount of energy which must be extracted from the system in this way is unknown. In contrast to the situation with conventional braking processes, it is therefore impossible in the case of wind energy installations simply to determine the energy converted during the braking process as the difference between the energy of the system at the start and the energy of the system at the end. According to the invention, the measured value is therefore recorded such that the energy supplied to the wind energy installation during the braking process is taken into account.

In one advantageous embodiment, the measured value comprises a measure for the braking travel. The braking travel is the distance through which the brake linings have to move on the brake disk between the start and the end of the braking process. It has been found that the method according to the invention produces good results just with the single assumption that the wear or the absorbed energy is proportional to the braking travel. The data which is required to determine the brake state characteristic value can then be determined easily. More precise results can be obtained with the method according to the invention by taking account of further measured values, such as the rotation speed, the time duration of the braking process, and/or the difference between the rotation speed at the start and at the end of the braking process. It is particularly advantageous to take account of a plurality of parameters in the measured value when the data relating to the load behavior of the wind energy installation is also available in a correspondingly detailed form.

The braking travel can be determined most easily by counting the number of revolutions between the start and the end of the braking process. It is also possible to deduce the braking travel from other measured values, such as the rotation speed at the start and at the end of the braking process, or the time duration of the braking process. Another form of measurement during the braking process is to record a measured value before the start or after the end of the braking process, from which it is possible to deduce an associated value during the braking process directly. By way of example, because of the inertia, the rotation speed shortly before the start of a braking process is substantially identical to the rotor rotation speed shortly after the start of the braking process.

Alternatively, the method according to the invention can also be carried out without explicitly determining the braking travel. Data is then required to produce a direct relationship between the relevant measured values (for example time, rotation speed, rotation speed difference) and the desired brake state characteristic value. The invention covers the recording of measured values only at the start and at the end of the braking process. Alternatively, a multiplicity of measured values can be recorded during the braking process. In particular, in this case, it is considered to be advantageous to continuously or quasi-continuously record the measurement variable, in order to record all the available information at as high a sampling rate as possible, in order to determine the brake state characteristic value accurately.

In one advantageous embodiment, the brake state characteristic value is determined in the situation in which the drive train does not come to rest during the braking process, taking account of the rotation speed of the drive train at the end of the braking process. If the drive train deliberately or accidentally does not come to rest during the braking process, important information relating to the state of the braking device can be derived from the rotation speed on deactivation of the braking device.

The measured values are preferably recorded using sensors which are provided in any case in the wind energy installation, independently of the monitoring of the brake. For example, these are sensors for the rotation speed or the time, which are required in the control system in order to set the wind energy installation to the correct operating point. The braking travel can be calculated from the measured values of the rotation speed and of the time. This embodiment does not require expensive sensors which are responsible only for monitoring of the brake.

In general, the braking process should be included in its totality in the brake state characteristic value. For this reason, the brake state characteristic value is frequently determined only after the end of the braking process. Providing the measured value after the end of the braking process ensures that an actually representative characteristic value of the brake state is used for the further control of the wind energy installation. If the braking process has not yet been completed, the further processing of the braking characteristic value could lead to incorrect results, since the brake state characteristic value could change further at very short notice.

One particularly advantageous method according to the invention provides for a brake cooling time, which is required for the brake to cool down, to be determined from the brake state characteristic value. The braking device, for example the brake disk, is heated to a major extent by a braking process. For safety reasons, it is frequently necessary to prevent operation of the wind energy installation until the braking device has cooled down sufficiently. In the prior art, the brake cooling time is a preselected parameter which must be chosen such that the brake has just cooled down sufficiently in the worst conditions.

Since no electricity can be produced during the waiting time, loss of yield resulting from the waiting time is, of course, undesirable. The invention now makes it possible to determine the brake cooling time individually after each braking process such that energy production can be resumed as quickly as possible.

One particularly advantageous method according to the invention provides for a wear characteristic value, which characterizes the brake wear, to be determined from the brake state characteristic value. It is therefore possible to determine the wear of the braking device and its progress without a sensor, which is susceptible to defects, in the brake linings. This avoids the costly sensor and the complex maintenance, while additionally improving the installation safety, because wear determination is safer, because the sensors are considerably more reliable.

Information both relating to the temperature and relating to the wear of the braking apparatus is preferably determined on the basis of the same measured values (for example braking travel) and using the data relating to the load behavior. The invention also covers only one of the information items being obtained in this way, and direct determination by a dedicated sensor being provided for the other information item. The temperature can therefore be determined from a measured value such as the braking travel, for example, while the wear is measured directly be means of a dedicated sensor. Alternatively, the wear can be determined from a measured value such as the braking travel, while the temperature is measured directly by means of a dedicated sensor.

Particularly when the intention is to also determine the wear from the brake state characteristic value, it may be advantageous to determine the brake state characteristic value more accurately, rather than on the basis of assumptions which are as simple as possible. For this purpose it is possible for the braking process to be subdivided into a multiplicity of short sections when determining the brake state characteristic value, and to determine the influence on the brake state characteristic value individually for each section. By way of example, the instantaneous rotation speed can be taken into account for each section. A correspondingly large number of measured values are preferably recorded during the braking process. It is therefore possible to take better account of the fact that the braking of a rotor is normally a non-linear process. This avoids the accumulation of errors resulting from inaccurate recording of the braking process over a multiplicity of braking processes leading to a major error in the brake state characteristic value.

In this case, it is particularly advantageous to record a measurement variable which represents an operating parameter of the wind energy installation that varies dynamically during the braking process, and to determine the brake state characteristic value from the change in the measurement variable during the braking process. In this case, dynamically means in particular parameters of the wind energy installation which do not vary linearly with the time, but follow more complex relationships which are predetermined, for example by the overall installation dynamics. Although the evaluation of dynamic measurement variables requires greater computation complexity, this also allows the brake state to be determined in more detail, however.

In braking apparatuses in wind energy installations, the force with which the brake linings rest on the brake disk is in general constant, or at least has fixed graduations. A multiplicity of conclusions can therefore be drawn relatively easily from the braking travel, for example relating to the braking energy absorbed by the brake and relating to the wear. If the force is variable, it is correspondingly more complex to determine the data which is used to determine the brake state characteristic value.

The method is generally used for a braking apparatus for braking a drive train which is connected to the rotor of the wind energy installation. The braking apparatus can act directly on the rotor shaft. If a transmission is provided in the drive train, the braking apparatus can be arranged on the side of the transmission remote from the rotor. The so-called rotor brake is actually particularly important for the safety of the wind energy installation, and it is therefore particularly worth using the invention to determine the brake state characteristic value. The invention can also be used for other braking apparatuses which are used, for example, to fix the machine housing of the wind energy installation relative to the tower.

The invention also relates to a wind energy installation for carrying out the method. The wind energy installation comprises a braking apparatus, a sensor and a control unit. The control unit is designed to instruct the sensor to record a measured value in the time period between the start of a braking process and the end of a braking process. A data memory is also provided, in which data is stored relating to the load behavior of braking apparatuses of the relevant type. Finally, the wind energy installation comprises a computation module, which determines a brake state characteristic value from the data and the measured value.

In advantageous embodiments, the computation module is designed to calculate a brake cooling time and/or a wear characteristic value from the brake state characteristic value. The measured value recorded using the sensor is preferably a measured value which is also processed independently of monitoring of the brake in the control unit, for example in order to determine a suitable operating point for the wind energy installation. The operating point is determined on the basis of parameters such as the pitch angle of the rotor blades, the voltage, the power, and the proportions of real power and reactive power. Measured values relating, for example, to the rotation speed or rotation speed changes cannot be included in the determination of these parameters. There is then no need to equip the wind energy installation with expensive sensors solely for the purpose of monitoring the brake.

The wind energy installation can be combined with further features of the method according to the invention, as described above.

### BRIEF DESCRIPTION OF THE DRAWINGS

The invention will be described in the following text by way of example using advantageous embodiments and with reference to the attached drawings, in which:

FIG. 1 shows an external view of a wind energy installation according to the invention;

FIG. 2 shows a schematic illustration of components of the wind energy installation from FIG. 1; and

FIG. 3 shows a flowchart of one embodiment of the method according to the invention.

### DETAILED DESCRIPTION OF THE INVENTION

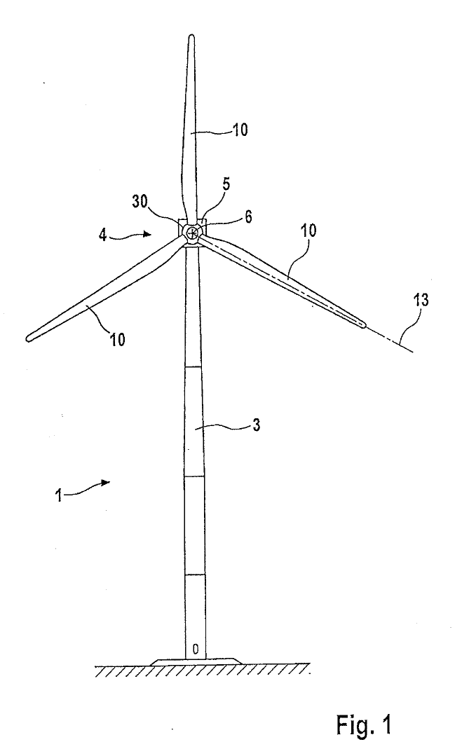

FIG. 1 shows a wind energy installation 1 with a tower 3, a machine housing which is mounted on the tower such that it can rotate about a vertical wind readjustment axis, a rotor 4 which is mounted such that it can rotate about a substantially horizontal axis 6 and has a rotor hub 30 on which three rotor blades 10 are arranged. The rotor blades are arranged on the rotor hub 30 such that the pitch angle is adjustable about a blade adjustment axis 13, which is shown by way of example for one rotor blade 10 in FIG. 1 and coincides substantially with the blade longitudinal axis.

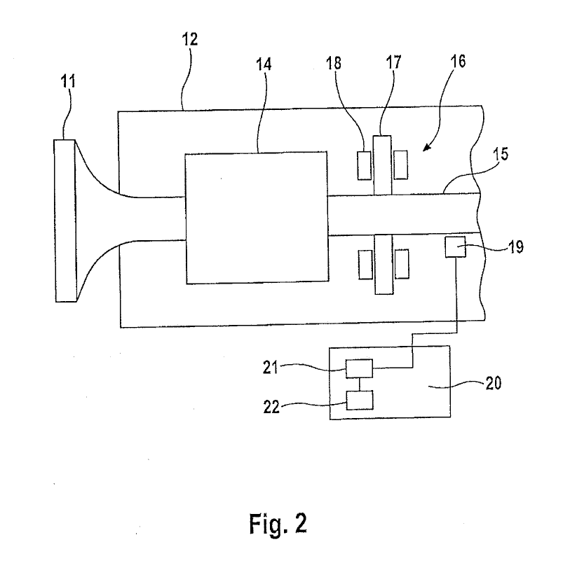

Some of the components of the wind energy installation from FIG. 1 are illustrated schematically in FIG. 2. A rotor shaft 11 extends into the machine housing 12, and opens in a transmission 14. The slow rotation of the rotor blades 11 is stepped up to a higher rotation speed in the transmission 14, and is transmitted to a generator shaft 15. The generator shaft 15 drives a generator, which is not illustrated but is used to produce electrical power.

A braking apparatus 16 which comprises a brake disk 17 connected to the generator shaft 15 as well brake calipers with brake linings 18 acts on the generator shaft. The braking apparatus 16 is used to brake the rotor 4. During a braking process, the brake linings 18 rub on the brake disk 17, with the pressure with which the brake linings 18 rest on the brake disk 17 always being the same.

The braking process starts when the brake linings 18 are brought into contact with the brake disk 17. In one alternative, the braking process ends when the generator shaft 15 has come to rest. This is the case when the rotor 4 is first of all braked aerodynamically by adjusting the pitch angle of the rotor blades 10, and is then brought to rest completely by the braking apparatus 16. In another alternative, the braking process ends at the time at which the brake linings 18 are detached from the brake disk 17 again, while the generator shaft 15 is still rotating. A braking process such as this is carried out during operation, for example, when the rotor 4 is intended to be brought to a different rotation speed at short notice, in order to avoid a load peak.

A sensor 19 which counts the revolutions of the generator shaft 15 is fitted to the generator shaft 15. A control unit 20 transmits to the sensor 19 the command to start counting the revolutions at the start of a braking process. At the end of the braking process, the sensor 19 transmits as the measured value the information to the control unit 20 on the number of revolutions over which the braking process has extended. Taking account of the diameter of the brake disk 17, a computation module 21 calculates the braking travel over which the brake linings 18 have moved back relative to the brake disk 17 during the braking process. In one alternative embodiment, the braking travel that has been moved through is assumed in a simplified form to comprise the braking time and the rotation-speed difference multiplied by a proportionality constant K_w (linearization of the rotation-speed profile).

Information relating to the load behavior of the braking apparatus 16 is stored in a data memory 22. The data comprises, for example, the information as to how severely the braking apparatus 16 is heated in specific conditions, or how much material is worn away from the brake linings 18 and the brake disk 17 during specific braking processes. In the simplest case, a linear relationship can be assumed between the braking travel and the wear and/or the temperature increase. This data need be calculated only once for braking apparatuses of this type, and it can then be used for all relevant braking apparatuses. More accurate results can be obtained by also taking account of further parameters of the braking process, such as the duration of the braking process, the rotation speed or the rotation-speed difference between the start and the end of the braking process.

Advantageous developments of the invention are distinguished in that the physical reality is mapped more accurately in the measured values and the data relating to the load behavior. For this purpose, in particular, the braking travel carried out can also be recorded in a non-linear form by addition of a multiplicity of rotation-speed differences relating to predetermined time intervals. More complex relationships such as the rotation-speed dependency and temperature dependency can also advantageously be recorded for wear determination. The brake temperature can be determined by means of the calculation approach, which is adequately well known from the prior art, based on the kinetic energy that is introduced, for which purpose the square of the rotation speeds is then included in the wear. The brake cooling time can likewise also be calculated on the basis of the (kinetic) energy introduced and additionally of the heat dissipation, which is dependent on the ambient temperature. Mathematical models such as these are sufficiently well known from simulation methods.

The computation module 21 reads appropriate data from the data memory 22, and uses the braking travel and the data to calculate a brake state characteristic value. The brake state characteristic value may, for example, include the information that the temperature increased by a value X during the last braking process, and the brake disk temperature is now Y. In addition, for example, this may include the information that specific amounts of material were removed from the brake disk 17 and the brake linings 18 during the last braking process. In order to obtain a more precise result for the brake state characteristic value, further measured values can be taken into account in the calculation, such as time measurements or measured values from a rotation-speed sensor, which is not illustrated. The greater the number of measured values which are taken into account relating to the braking process and the more accurately the data stored in the data memory 20 is matched to these measured values, the more precisely statements can be derived from the brake state characteristic value.

In the next step, the computation module 21 can derive further information from the brake state characteristic value. For example, a brake cooling time can be calculated from the temperature of the braking apparatus 16 at the end of the braking process. The brake cooling time is the time period after which the installation can resume normal operation. For a wind energy installation which has been braked to rest, this means that it cannot resume operation until the brake cooling time has elapsed.

In addition, a wear characteristic value can be calculated from the brake state characteristic value. The wear characteristic value may, for example, be such that the installation is stopped if a predetermined limit value is exceeded, in which case a maintenance message is, of course, sent to a remote monitoring center in order that a maintenance action is carried out as quickly as possible. If only an alarm threshold is exceeded, the remote monitoring center is informed by a warning message.

Within the scope of the invention, one advantageous embodiment provides for different wear characteristic values to be determined for different components of the brake, which wear characteristic values are reset at different times when the respective component is replaced. For example, a brake lining has a considerably shorter life than a brake disk. After the parts of the brake which are subject to wear have been replaced, in particular the brake linings, the wear characteristic value can be reset to zero again.

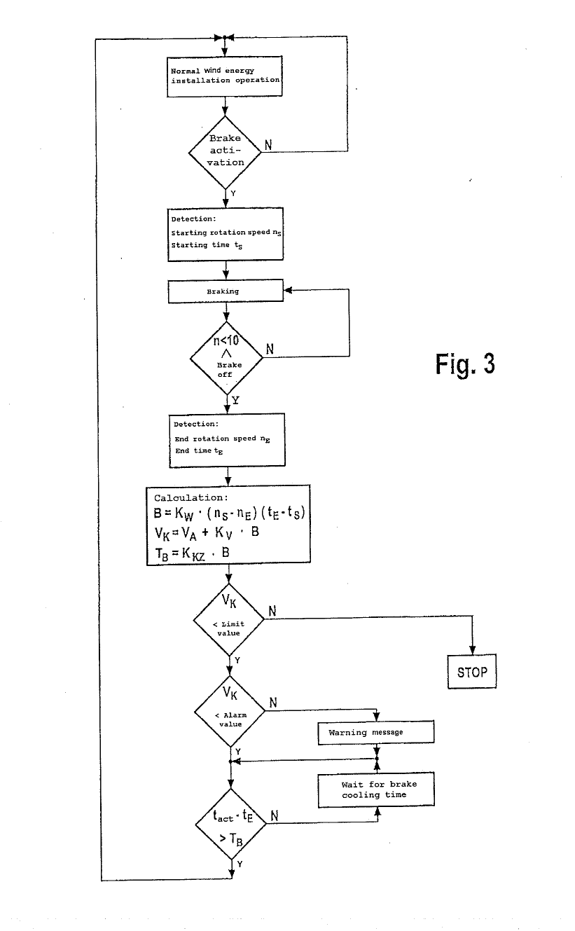

FIG. 3 shows the flowchart for the process for a simple embodiment of the method according to the invention. During normal operation of the wind energy installation 1, checking is continuously carried out to determine whether the braking apparatus 16 has been activated. If this is the case, the control unit 2 sends a signal to relevant sensors which record the starting rotation speed nₛ and the starting time tₛ as measured values. During the braking process, checking is carried out continuously to determine whether the braking process has ended, that is to say whether the brake has been switched off (released) or the rotation speed is less than a predeterminable limit value, for example 10 revolutions on the generator side (in the case of a high-speed generator with a synchronous rotation speed of 1500 revolutions). The end rotation speed n_{E} and the end time t_{E} are determined at the end of the braking process.

After the end of the braking process, the braking travel is calculated as the product of the rotation-speed difference (n_{S}−n_{E}), the duration of the braking process (t_{S}−t_{E}) and a proportionality constant K_{W}. The wear caused by the braking process is calculated as the product of a proportionality constant K_{V} and the braking travel B. A wear value V_{A} which was applicable before the braking process is added in order to determine a wear characteristic value V_{K} from this brake state characteristic value. The brake cooling time T_{B} is determined as the product of the braking travel B and a proportionality constant K_{KZ}. The actual brake state characteristic value, specifically the temperature of the braking apparatus 16 after the braking process, is in this case included only implicitly in the calculation, or the required brake cooling time T_{B} is an indirect measure of the brake state, specifically the brake temperature.

If the wear characteristic value V_{K} exceeds a predetermined limit value, the wind energy installation 1 is taken out of operation. If the limit value is still being complied with, a check is carried out in the next step to determine whether the wear characteristic value V_{K} has exceeded an alarm value. If this is the case, a warning message is output.

A check is carried out in the next step to determine whether the time which has passed between the present time t_{act} and the end of the braking process t_{E} is greater than the brake cooling time T_{B}. Normal operation of the wind energy installation cannot be continued until this is the case.

In one exemplary embodiment, the procedure for determining the brake cooling time T_{B} is as follows. When the braking apparatus 16 is closed, the starting rotation speed n_{S} and the starting time i_{S} are stored. When the brake is opened or when the rotation speed has fallen to less than 10 rpm, the end time t_{E} is stored. The brake cooling time T_{B} can then be calculated using the following formula:

$${T}_{B} = \frac{{n}_{S} * ( {t}_{E} - {τ}_{A} )}{2} * \frac{Fixed value - cooling time}{200}$$

In this case, the starting rotation speed n_{S} should be stated in units 1/s, and the time in s. The result is the brake cooling time T_{B} in minutes. The fixed value cooling time is 60 min and, as in the case of the other constants, was determined empirically. The use of the formula results in the following examples of values for the brake cooling time T_{B}.

| Starting rotation | | |
|---|---|---|
| speed n_{S} | Braking time | Cooling time T_{B} |
| (rpm) | (t_{E}-t_{A})/s | (min) |
| 1750 | 14 | 61.3 |
| 1800 | 10 | 45.0 |
| 500 | 4 | 5.0 |
| 200 | 2 | 1.0 |
| 1000 | 5 | 12.5 |
| 1200 | 50 | 150.0 |

If the number of revolutions carried out during the braking process is considerably greater than 200, the brake will have been overheated.

1. A method for monitoring the state of a braking apparatus of a wind energy installation, comprising:
monitoring a braking apparatus;
obtaining data relating to load behavior of the braking apparatus;
recording a measured value during a time period between a start of a braking process and an end of the braking process; and
determining a brake state characteristic value based on the data and the measured value.

2. The method of claim 1, wherein the measured value comprises a measure for braking travel of the braking apparatus.

3. The method of claim 1, wherein the measured value comprises a measure for a difference between a rotation speed at the start of the braking process and a rotation speed at the end of the braking process.

4. The method of claim 1, wherein the measured value comprises a measure for a duration of the braking process.

5. The method of claim 1, wherein the measured value is recorded independently of the monitoring of the braking apparatus using a sensor included in the wind energy installation.

6. The method of claim 1, wherein the brake state characteristic value is determined after the end of the braking process.

7. The method of claim 1, further comprising determining a brake cooling time (T_{B}) based on the brake state characteristic value.

8. The method of claim 1, further comprising determining a wear characteristic value (V_{K}) from based on the brake state characteristic value.

9. A wind energy installation comprising:
a braking apparatus;
a sensor;
a control unit configured to instruct the sensor to record a measured value in a time period between a start of a braking process and an end of a braking process;
a data memory configured to store data relating to load behavior of the braking apparatus; and
a computation module configured to determine a brake state characteristic value based on the data and the measured value.

10. The wind energy installation of claim 9, wherein the computation module is configured to calculate a brake cooling time (T_{B}) based on the brake state characteristic value.

11. The wind energy installation of claim 9, wherein the computation module is configured to calculate a wear characteristic value (V_{K}) based on the brake state characteristic value.

12. The wind energy installation of claim 9, wherein the control unit is configured to process measured values recorded using the sensor to determine a suitable operating point for the wind energy installation.
